(19) United States
(12) Patent Application Publication
(10) Pub. No.: US 2006/0220986 A1
(43) Pub. Date: Oct. 5, 2006

(54) Display method and display apparatus

(76) Inventors: Masaaki Takabe, Tokyo (JP); Kosuke Yamaguchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/554,095

(22) PCT Filed: Apr. 13, 2004
(86) PCT No.: PCT/JP04/05245

§ 371 Date: Oct. 21, 2005

(30) Foreign Application Priority Data
Apr. 23, 2003 (JP) 2003-118822

(51) Int. Cl. G09G 5/00

(52) U.S. Cl. 345/9

(57) ABSTRACT

In order to display a large number of images on one screen efficiently and simultaneously, it is arranged that, in case of displaying a plurality of images on the screen in a reduced size, the plurality of images to each of which a related time is added are stored; a time axis is established on the screen; each image is disposed in the vicinity of a position on the time axis corresponding to the time added to each image; and each image is displayed in order and at intervals corresponding to the time.

### TECHNICAL FIELD

The present invention relates to a display method and display apparatus suitable for simultaneously displaying a plurality of images picked up by, for example, a digital camera on a screen in a reduced size.

### BACKGROUND ART

Conventionally, there has been cases where what is called a thumbnail display is performed, in which, to retrieve images picked up by a digital camera, a plurality of picked-up images are disposed side by side in a reduced size, for example, on a display panel incorporated in the digital camera or on an external display unit connected to the digital camera.

Specifically, the digital camera is capable of storing still images from several tens to several hundreds or so in a built-in memory or in an incorporated memory card and the like, and when the stored images are retrieved, there may be performed the display in which a plurality of picked-up images are disposed side by side in a reduced size.

FIG. 9 shows an example of the thumbnail display in the past. This example is such one that sixteen frames of still images 901 to 916 are simultaneously displayed on one screen 900. By making key operation corresponding to page turning, the next sixteen frames of images are displayed and a desired image can be found out from among images displayed successively. By performing operation to select the found-out image, it is possible to display the selected image in an enlarged size.

There is a description on disposing the plurality of images side by side like this example in Patent Gazette of Published Patent Application No. 2002-74322 issued from Japanese Patent Office. Although the Patent Gazette of Published Patent Application No. 2002-74322 discloses an example of the thumbnail display higher in degree than the example in FIG. 9, the described processing is basically the same as that of the example in FIG. 9 in that images are disposed side by side and displayed in a predetermined order.

However, if only a plurality of images are disposed merely side by side for display as shown in FIG. 9, it takes time to find out a desired image, which poses a problem. Because images are only disposed side by side for display merely in a photographing order in prior art, in such a case that a user desires to extract an image picked up on the specific date and time, there is no alternative but to find it out from among images displayed in a photographing order by making the page turning and so on until the image picked up on that date and time become displayed.

For example, assuming that only images picked up yesterday should be extracted on a trip, there is no way but to collate the images with one's memory or to select by looking at data such as the date. Moreover, when a large number of images are picked up once, even if one desires to look at those images together, it is difficult to do such a thing.

An object of the present invention is to display a large number of images on one screen efficiently and simultaneously.

### DISCLOSURE OF THE INVENTION

A first aspect of the present invention is a method for displaying a plurality of images on one screen in a reduced size, including the steps of:

storing the plurality of images to each of which a related time is added,

establishing a time axis on the screen,

disposing each image in the vicinity of a position on the time axis corresponding to the time added to each image, and

displaying each image in order and at intervals corresponding to the time.

By doing in this way, approximate date and time when each image is picked up or the like can be estimated from the position of each image displayed in order and at intervals along the time axis on the screen, and the desired image can easily be found out from the position on the time axis.

A second aspect of the present invention is a display method according to the first aspect of the present invention, wherein

when each image disposed in the vicinity of the time axis overlaps with an display area of another image having an adjacent time on the time axis, only part not overlapped of a display area of each image is displayed.

By doing so, a large number of images can simultaneously be displayed efficiently on one display screen.

A third aspect of the present invention is a display method according to the first aspect of the present invention, wherein

each image displayed along the time axis is displayed as an oblique one having a predetermined angle to the screen.

By doing so, a large number of overlapped images can be displayed as oblique ones simultaneously, which makes an easy-to-understand display form along the time axis.

A fourth aspect of the present invention is a display method according to the first aspect of the present invention, wherein

intervals between a plurality of disposed images are made variable by changing a scale of the time axis based on a predetermined operation.

By doing in this way, for example, first a range including images picked up on an objective date is found out, then a scale of the time axis in the range including images picked up on that date is enlarged to dispose on the whole screen the images picked up on that date side by side, and so an objective image can easily be reached.

A fifth aspect of the present invention is a display method according to the first aspect of the present invention, wherein

the time added to each image is the date and time when the image is picked up.

By doing so, the date and time when the image is picked up can be recognized easily.

A sixth aspect of the present invention is a display apparatus including:

storage means for storing a plurality of image data to each of which a related time is added,

display means for displaying images based on the image data stored in the storage means, and

display processing means for establishing a time axis on the screen displayed in the display means, for disposing each image in the vicinity of a position on the time axis corresponding to the time added to each image stored in the storage means, and for displaying each image in order and at intervals corresponding to the time.

By doing in this way, approximate date and time when each image is picked up can be estimated from a position of each image displayed in order and at intervals along the time axis on the screen, and such a display is performed as a desired image can easily be found out from the position on the time axis.

A seventh aspect of the present invention is a display apparatus according to the sixth aspect of the present invention, wherein

when each image disposed in the vicinity of the time axis overlaps with a display area of another image having an adjacent time on the time axis, the display processing means display only part not overlapped of a display area of each image.

By doing so, a large number of images can be displayed efficiently on one display screen simultaneously.

An eighth aspect of the present invention is a display apparatus according to the sixth aspect of the present invention, wherein

the display processing means make each image that is displayed along the time axis displayed as an oblique one having a predetermined angle to the screen.

By doing so, a large number of overlapped images can be displayed as oblique ones simultaneously, which makes an easy-to-understand display form along the time axis.

A ninth aspect of the present invention is a display apparatus according to the sixth aspect of the present invention, wherein

based on predetermined instructions, the display processing means change intervals between a plurality of disposed images by changing a scale of the time axis.

By doing in this way, for example, first a range including images picked up on an objective date is found out, then a scale of the time axis in the range including images picked up on that date is enlarged to dispose on the whole screen the images picked up on that date side by side, and so such a display is performed as an objective image can easily be reached.

A tenth aspect of the present invention is a display apparatus according to the sixth aspect of the present invention, wherein

the time added to each image data stored in the storage means is the date and time when the image is picked up.

By doing so, such a display can be performed as is capable of informing easily the date and time when the image is picked up.

### BRIEF DESCRIPTION OF DRAWINGS

FIG. 1 is a block diagram showing an example of a configuration of a digital camera according to an embodiment of the present invention;

FIG. 2 is a flowchart showing an example of processing to display the thumbnail image according to an embodiment of the present invention;

FIG. 3 is an explanatory diagram showing a display example according to an embodiment of the present invention;

FIG. 4 is an explanatory diagram showing a display example (in which a time scale is changed) according to an embodiment of the present invention;

FIG. 5 is an explanatory diagram showing a display example (in which a specific image is extracted) according to an embodiment of the present invention;

FIG. 6 is an explanatory diagram showing a display example according to another embodiment of the present invention;

FIG. 7 is an explanatory diagram showing a display example according to another embodiment of the present invention;

FIG. 8 is an explanatory diagram showing a display example according to another embodiment of the present invention; and

FIG. 9 is an explanatory diagram showing an example of the thumbnail display of related art.

### BEST MODE FOR CARRYING OUT THE INVENTION

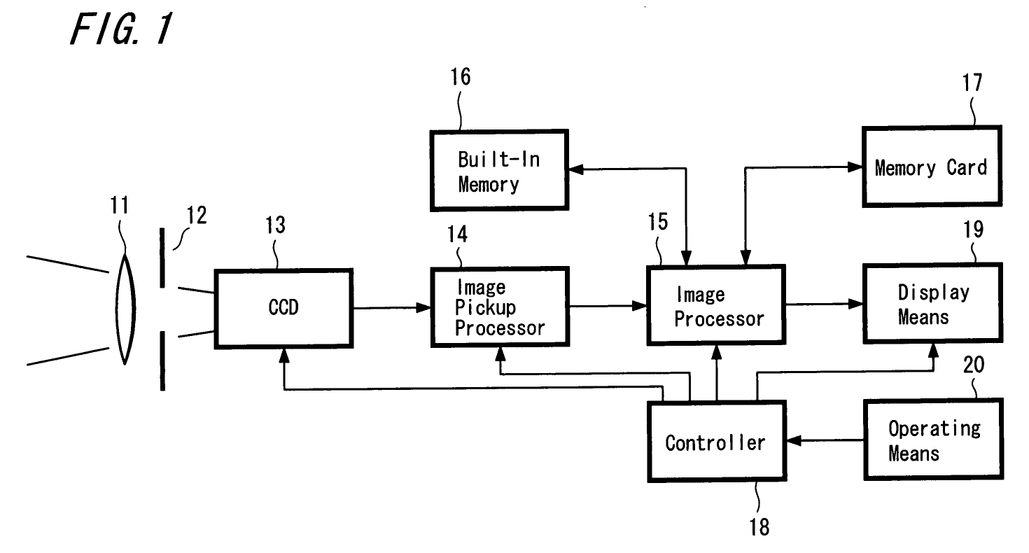

Hereinafter, an embodiment of the present invention will be described with reference to FIGS. 1 to 8.

In this embodiment, the present invention is applied to an electronic device termed a digital camera which photographs (picks up) a still image or moving image to store the obtained picked-up image data in storage means (or recording means) such as a semiconductor memory. The digital camera in this example is designed to be capable of displaying a picked up image on display means formed of a liquid crystal display panel and so on and of photographing while confirming an image displayed on the display panel.

FIG. 1 shows an example of the whole configuration of the digital camera. Image light formed on the surface of an image pickup device 13 such as a CCD image pickup device through an optical system 11 and so on is read out as an electric signal, which is supplied to an image pickup processor 14. In this case, an iris mechanism 12 is arranged in an optical path where a lens 11 and so on are disposed.

The image pickup processor 14 performs processing of converting a picked-up image signal read from the image pickup device 13 into an image signal of a predetermined format (picture signal), and the image signal output from the image pickup processor 14 is supplied to an image processor 15 which performs various kinds of image processing. The image processor 15 also performs image processing of making the thumbnail display on display means 19 described later on and image processing of superimposing various characters, numerals, figures and the like on the image displayed on display means 19.

The image signal for display, which is processed in the image processor 15, is supplied to the display means 19 which displays the picked-up image on a display panel included in the display means 19. For the display panel, for example, a liquid-crystal display panel is employed. Further, a built-in memory 16 and a memory card 17 are connected to the image processor 15, which can store in the built-in memory 16 or memory card 17 the image picked up with predetermined timing. The memory card 17 is a storage medium which is attached and detached freely to and from the camera body.

A controller 18 controls image pickup processing with the image pickup device 13, signal processing in the image pickup processor 14 and image processor 15, display processing with the display means 19, and storage processing of image signal in the built-in memory 16 or memory card 17. To the controller 18 is connected operating means 20 including an operation key, dial and so on, and the controller 18 controls photographing operation based on the operation with the operating means 20. For example, when a shutter button prepared as the operating means 20 is depressed, such image pickup processing can be performed that the image signal picked up by the image pickup device 13 is processed in the image pickup processor 14 and image processor 15 and is stored in the built-in memory 16 or memory card 17. Further, it is designed that setting of various modes concerning image pickup can be performed under the control of the controller 18 based on operation with the operating means 20.

Hereupon, when the image signal is stored in the built-in memory 16 or memory card 17 by operating a shutter button or the like, information on image pickup at that time can be stored in the built-in memory 16 or memory card 17 as sub-data. The photographing date and time and photographing conditions at that time (shutter speed, f-stop number, setting conditions of various modes, and so on) can be stored as sub-data. To make the photographing date and time stored, the controller 18 has a function of counting the present date and time and makes data on the counted date and time stored simultaneously with storing the picked-up image data. Further, it is also possible to store characters, numerals and so on indicating a photographing place and comment as sub-data by user's input operation after the image pickup.

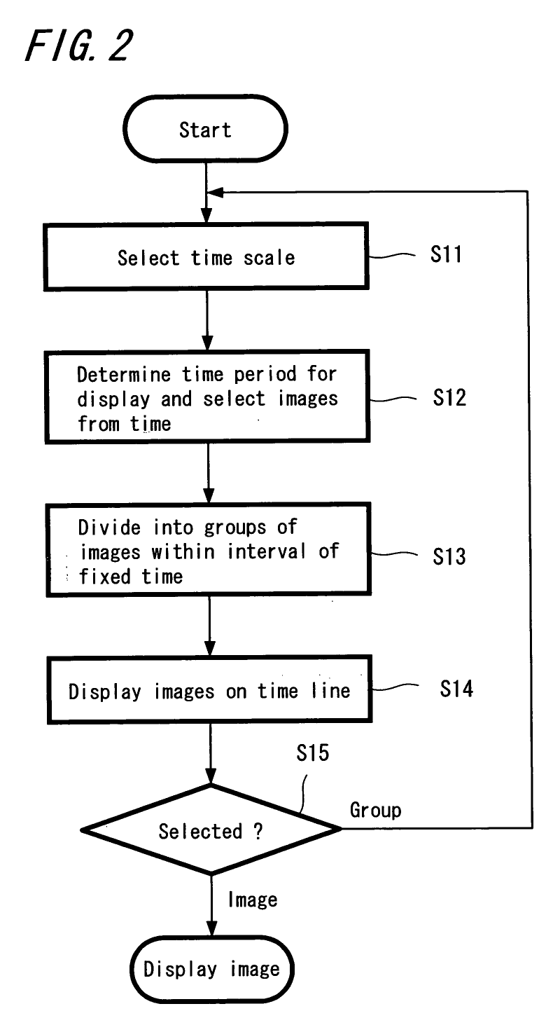

Further, the digital camera in this example is designed to perform a display along a time line (time axis), when the thumbnail display of images stored in the built-in memory 16 or memory card 17 is made with the display means 19. FIG. 2 is a flowchart showing an example of processing when performing the thumbnail display. The image processing is performed in the image processor 15 under the control of the controller 18, and here it is assumed that the thumbnail display of image stored, for example, in the memory card 17 is made. The memory card 17 stores plural frames of images, to each of which data on the photographing date and time is added.

When the thumbnail display is made, processing to select a range of time scale (time axis) displayed on the screen is performed first (step S11). In this case, if the time scale is selected by user's operation, the selected time scale is employed; and if, for example, the time scale is not selected, the controller 18 may select the time scale automatically. The time scale may be selected from among plural stages prepared in advance or may be established as variable ones.

Subsequently, a time period to be displayed is determined based on the selected time scale, and images having the photographing date and time which belongs to the time period to be displayed are selected from among all images stored in the memory card 17 (step S12). In addition, when the time scale is automatically selected in step S11, for example, a period between the oldest date and time and the latest date and time of all the photographing date and time of images stored in the memory card 17 may be defined as a range of the time scale.

Hereupon, the images selected in step S12 divided into groups of images within an interval of a fixed time (step S13). After dividing the images into groups, all images within the range of the time scale are displayed as reduced in size in order of the photographing date and time in the vicinity of each photographing date and time on the time line (step S14). On this occasion, the images divided into groups in step S13 are displayed as follows; a frame of image having the earliest photographing date and time within the relevant group is displayed, and the other images within that group are displayed only in part while each of them overlaps partly with the front image. In this state, it is estimated whether a specific image is selected or a specific group is selected from among the displayed images (step S15), and if the specific image is selected, the selected image is displayed in an enlarged size in the display means 19, and the thumbnail display is caused to stop.

If some group is selected in step S15, processing returns to step S11, where a time scale suitable for displaying that group is selected to perform processing of displaying the selected group of images with that time scale (steps S12, S13, and S14).

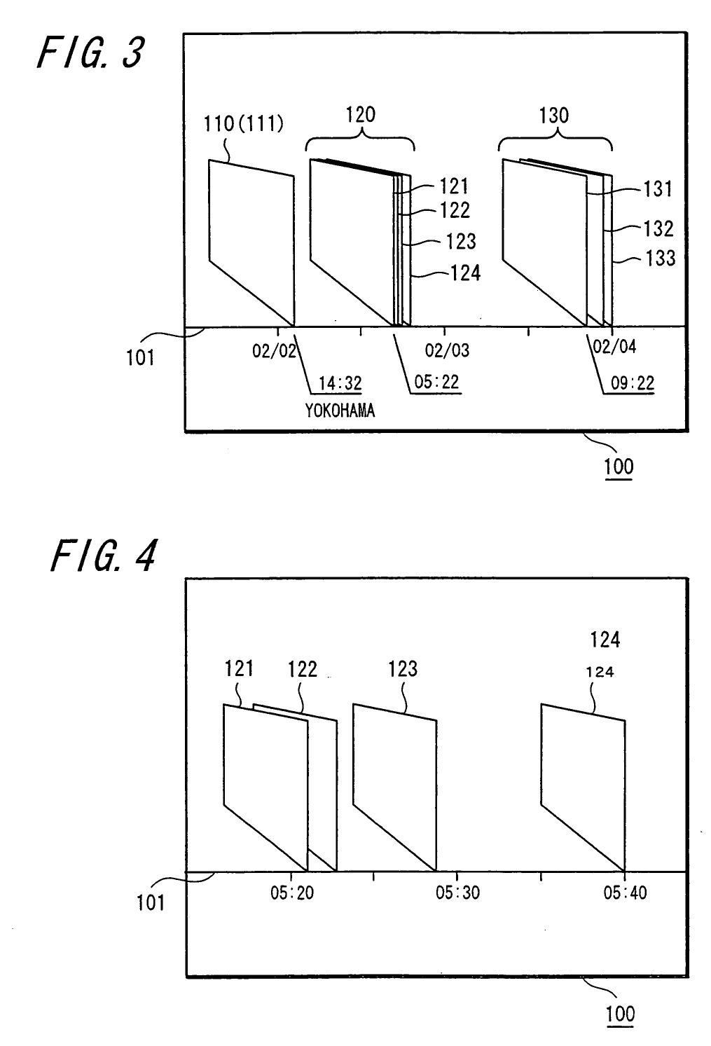

FIGS. 3 and 4 show display examples when the thumbnail display is made in this way. In these examples, each image displayed in a reduced size is an oblique one. As is shown in FIG. 3, a linear horizontal time scale 101 is established on the screen 100 displayed in the display means 19. In FIG. 3, the time scale ranges over about three days from February second (displayed as 02/02) to February fourth (displayed as 02/04), and images picked up for those three days are disposed in the vicinity of positions of the relevant date and time on the time scale in order and at intervals corresponding to that date and time. The date is displayed on the time scale.

The example of FIG. 3 is such one that eight frames of still image 111, 121, 122, 123, 124, 131, 132, and 133 are picked up and stored in the memory card 17 for the three days. In this case, images 121 to 124 are picked up at comparatively close times, and images 131 to 133 are also picked up at comparatively close times. When image pickup is performed in this manner, images are divided into three groups, a group 110 including an image 111, a group 120 including images 121 to 124, and a group 130 including images 131 to 133 in step S13 of the flowchart in FIG. 2.

Images 111, 121, 131 picked up at the earliest time in each of groups 110, 120, 130 are displayed completely in an oblique state and in a reduced size. As to the groups 120 and 130 each including plural frames of image, images 122, 123, 124, 132, and 133 picked up after that time are displayed except portions overlapping with the image positioned immediately ahead, that is, only images of non-overlapped portions (that is, edge portion in FIG. 3) are displayed.

Further, in the example of FIG. 3, each photographing time of images 111, 121, 131 picked up at the earliest time in each group 110, 120, 130 is indicated for every group. Moreover, in the case where a photographing place and the like are stored in the memory card 17, those data are also displayed together with photographing time. In the example of FIG. 3, photographing time 14:32 and photographing place “YOKOHAMA” of image 111 are displayed.

Furthermore, in the display state as shown in FIG. 3, if there is a key operation of, for example, shifting the screen leftward or rightward, a display range of the time scale (the date and time) will be changed in the respective directions; and in the case where there are picked-up images in the respective ranges, the respective picked-up images are displayed in a reduced size and in a similar arrangement.

In the state of display like this, if any operation is made to select some image, then display will be changed so that the image may be enlarged and displayed on the screen 100. In addition, such a display form may be employed that the selected image is recognized by changing a color of edge of the selected image, for example.

Further, when there is any operation of selecting some group instead of the operation of selecting a specific image, display processing is changed over to one with the time scale where the group of images is displayed. If, for example, the group 120 is selected in the state of display shown in FIG. 3, the display will be changed to one shown in FIG. 4. The display example in FIG. 4 has such a range of the time scale that at least the image 121 picked up first and the image 124 picked up latest in the group 120 are included appropriately.

With a display state shown in FIG. 4, four frames of images 121 to 124 in the group 120 are each disposed in the vicinity of positions of the relevant date and time on the time scale, and in order and at intervals corresponding to the photographing time. In the example of FIG. 4, three frames of images 121, 123, and 124 among the four frames of images are displayed in a state of not overlapping with the image immediately ahead, and the overlapped image 122 has an overlapped area less than that in the display example in FIG. 3 to confirm the respective images from the display favorably, as a result, selection of image can be made easily.

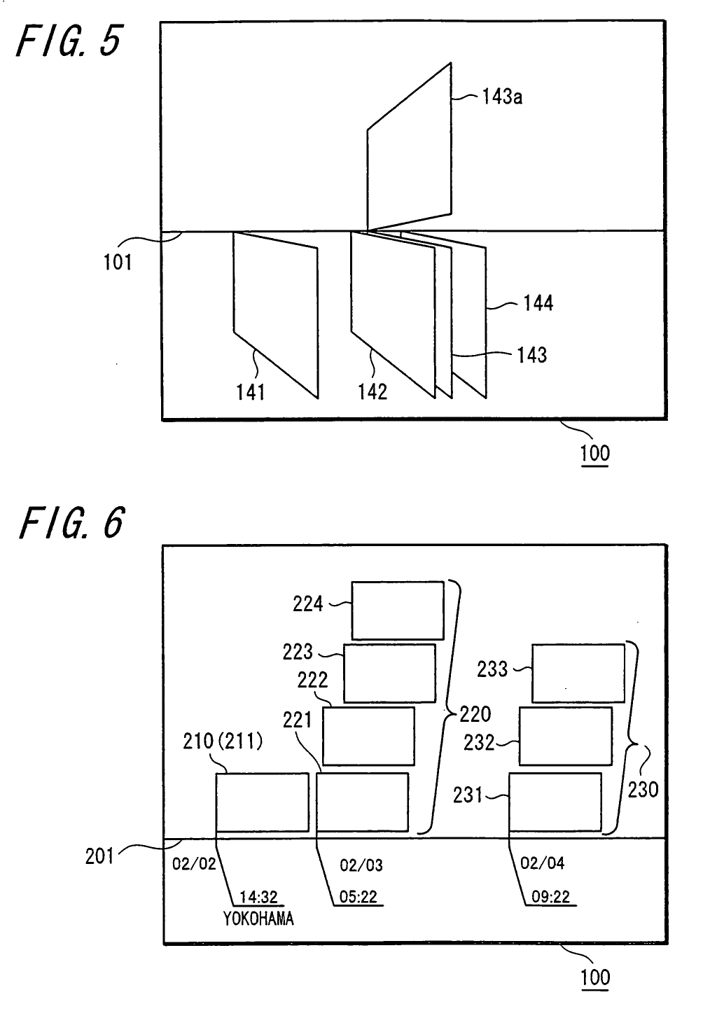

In addition, when a user desires to confirm the content of the image overlapped with the image immediately ahead as shown in FIGS. 3 and 4, the selected image may be displayed at another position on the screen in the reduced size. FIG. 5 shows a display example in this case. In this example, on the lower side of the time scale 101 disposed in almost the center of the screen 100 are displayed four frames of images 141, 142, 143, 144 in order and at intervals corresponding to the photographing date and time and in a reduced size. When operation of extracting an image 143 is made in this state, the same image as that is displayed as an image 143a on the upper side of the time scale 101 as shown in FIG. 5. With a display shown in FIG. 5, it is possible to confirm the content of any image still in the reduced size, even though the image is displayed as overlapped one on the time scale.

Moreover, in the examples shown in FIGS. 3 to 5, although those images are displayed as oblique ones along the time scale, the images may be displayed as planar ones.

Specifically, as is shown in FIG. 6 for example, a horizontal time scale 201 is established on the screen, on the upper side of which are disposed images 211 to 233 in order and at intervals corresponding to the photographing date and time. In this example, images are divided into three groups 210, 220, 230. The group 210 includes a frame of image 211. The group 220 includes four frames of images 221 to 224. The group 230 includes three frames of images 231 to 233.

In the examples of FIG. 6, the groups 220 and 230 including three frames and four frames of images respectively are disposed side by side in a vertical direction. Specifically, the group 220 is displayed with images 222, 223, 224 above the image 221 and the group 230 is displayed with images 232, 233 above the image 231. In this case, images are disposed in such a manner as to be each slightly shifted to the right (in the direction of display of the time scale) correspondingly to the photographing time, and an amount of the shift between the positions corresponds to a photographing interval. In case of the example of FIG. 6, photographing times of the first image in each group, characters of a photographing place and so on are also displayed.

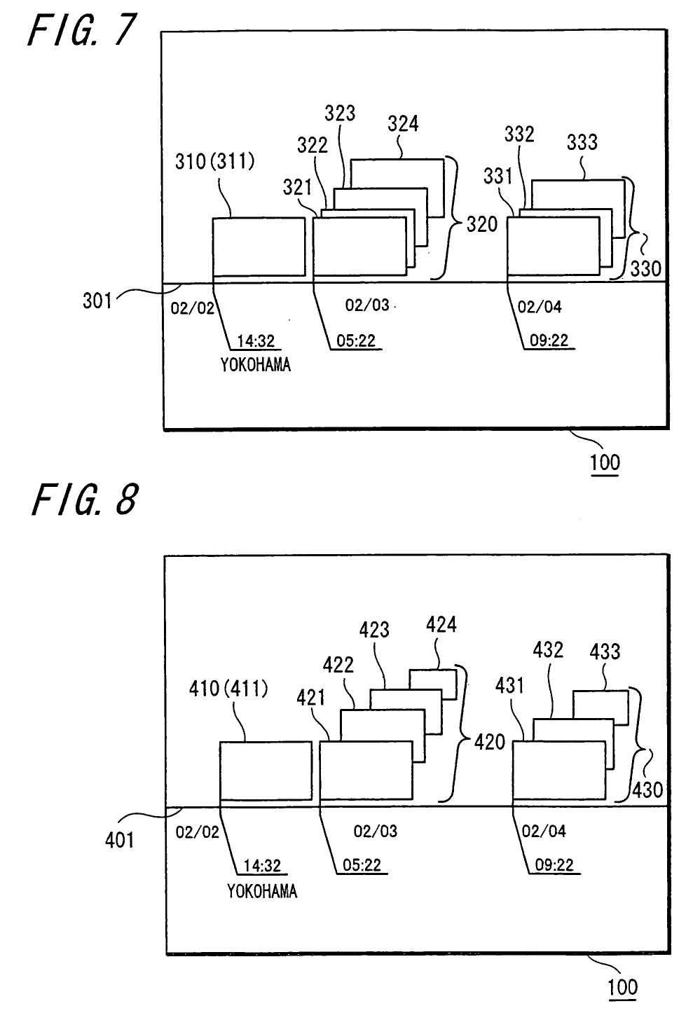

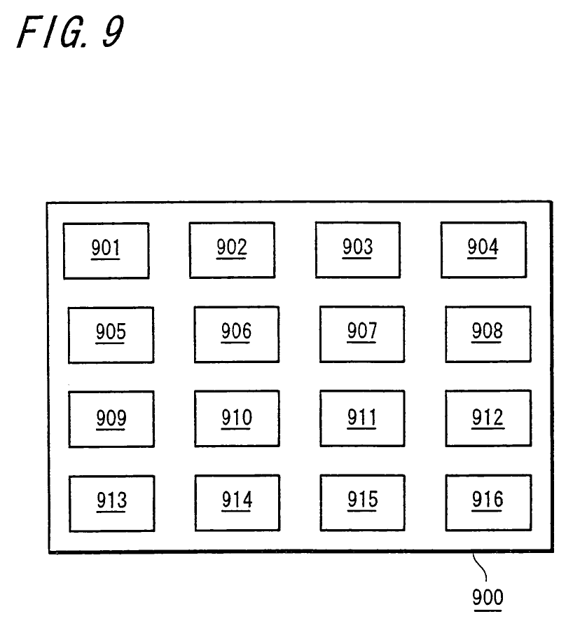

FIG. 7 shows an example in which, when images reduced in size are displayed as planar ones, images are overlapped in each group to be displayed. Specifically, in FIG. 7, a horizontal time scale 301 is established on the screen 100 and images 311 to 333 are disposed on the upper side of the time scale in order and at intervals corresponding to the photographing date and time. In this example, images are divided into three groups 310, 320, and 330; the group 310 includes a frame of image 311; the group 320 includes four frames of images 321 to 324; and the group 330 includes three frames of images 331 to 333.

In the example of FIG. 7, the three frames and four frames of images in the groups 320 and 330 respectively are overlapped side by side in a vertical direction, and only the first image in each group is displayed in full. In this case, each image is also slightly shifted to the right (in the direction of display of the time scale) correspondingly to the photographing time, and an amount of the shift between the positions corresponds to a photographing interval. In the example of FIG. 7, photographing time of the first image in each group, characters of a photographing place and so on are also displayed.

With the display as shown in FIG. 7, even though each group has many frames of images, the display thereof can be made satisfactorily and a disadvantage that limitation is imposed on the number of frames displayed as in the display example shown in FIG. 6 can be eliminated.

In addition, when images are overlapped to be displayed as shown in FIG. 7, the overlapped images displayed in the rear may be made smaller in size than images on the front side. FIG. 8 shows an example in which, when overlapped for display, images are gradually reduced in size. Specifically, as shown in FIG. 8 for example, a horizontal time scale 401 is established on the screen 100 and images 411 to 433 are disposed on the upper side of the time scale in order and at intervals corresponding to the photographing date and time. In this example, images are divided into three groups 410, 420, and 430; the group 410 includes a frame of image 411; the group 420 includes four frames of images 421 to 424; and the group 430 includes three frames of images 431 to 433.

In the example of FIG. 8, the three frames and four frames of images in groups 420 and 430 are overlapped vertically side by side, and only the first image in each group is displayed in full. Each image is also slightly shifted to the right (in the direction of display of the time scale) correspondingly to the photographing time, and an amount of the shift between the positions corresponds to a photographing interval. The example of FIG. 8 is the same as the example of FIG. 7 so far, but is different in that images displayed in the rear in each group are made smaller in size as they go backward.

In addition, even when images are overlapped to be displayed as the examples in FIGS. 7 and 8, the selected image may be displayed in another position on the screen 100 in the reduced size as shown in FIG. 5.

Each display example has heretofore been described only by way of example, and so the other display form may be employed as a matter of course. For example, although the time scale is shown as a straight line arranged in the horizontal direction in each example described above, the time scale may be a straight line arranged in the vertical direction or a curvilinear time scale. Further, although the time scale is changed when the group is selected in the above-described examples, the time scale may be changed in another processing. For example, it may be arranged that a time scale desired to display is directly selected from among plural stages of time scales prepared beforehand, by user's key operation or the like.

Further, while the above-described embodiments are applied to the case where still images picked up by a digital camera are displayed, they are also applicable to a case where plural representative images among moving images are displayed by the same processing simultaneously.

Moreover, although the above-described embodiments are examples in which images are displayed on a display panel incorporated in a digital camera, the same display processing may be performed when the digital camera is connected to an external display unit (display means) such as a monitor image receiver or a display of a personal computer device, where images stored in the digital camera are displayed.

Furthermore, the same display processing may be performed when an image processor such as a personal computer device is made to acquire a plurality of still image data (or moving image data) for making a display connected to the processor display the plurality of images simultaneously. In this case, the same display processing may be performed by making the image processing for displaying a plurality of images along a time axis according to the present invention into a program and by installing a medium storing the program in the computer device.

1. A display method of displaying a plurality of images in a reduced size on a screen, comprising the steps of:
storing said plurality of images to each of which a related time is added,
establishing a time axis on the screen,
disposing each image in the vicinity of a position on said time axis corresponding to the time added to each image, and
displaying each image in order and at intervals corresponding to the time.

2. A display method according to claim 1,
wherein when each image disposed in the vicinity of said time axis overlaps with a display area of another image having adjacent time on said time axis, only part not overlapped of a display area of each image is displayed.

3. A display method according to claim 1,
wherein each image displayed along said time axis is displayed as an oblique image having a predetermined angle to the screen.

4. A display method according to claim 1,
wherein intervals between a plurality of disposed images are made variable by changing a scale of said time axis based on a predetermined operation.

5. A display method according to claim 1,
wherein the time added to each image is the date and time when the image is picked up.

6. A display apparatus comprising:
storage means for storing a plurality of image data to each of which a related time is added,
display means for displaying images based on the image data stored in said storage means, and
display processing means for establishing a time axis on the screen displayed in said display means, for disposing each image in the vicinity of a position on said time axis corresponding to the time added to each image stored in said storage means, and for displaying each image in order and at intervals corresponding to the time.

7. A display apparatus according to claim 6,
wherein when each image disposed in the vicinity of said time axis overlaps with a display area of another image having an adjacent time on said time axis, said display processing means display only part not overlapped of a display area of each image.

8. A display apparatus according to claim 6,
wherein said display processing means display each image along said time axis as an oblique image having a predetermined angle to the screen.

9. A display apparatus according to claim 6,
wherein based on predetermined instructions, said display processing means change intervals between a plurality of disposed images by changing a scale of said time axis.

10. A display apparatus according to claim 6,
wherein the time added to each image data stored in said storage means is the date and time when the image is picked up.
